(19) United States
(12) Patent Application Publication
(10) Pub. No.: US 2022/0217492 A1
(43) Pub. Date: Jul. 7, 2022

(54) METHOD OF APPLYING DOPPLER EFFECT TO OBJECT AUDIO SIGNAL AND RENDERING APPARATUS PERFORMING THE METHOD

(71) Applicant: ELECTRONICS AND TELECOMMUNICATIONS RESEARCH INSTITUTE, Daejeon (KR)

(72) Inventors: Yong Ju LEE, Daejeon (KR); Jae-hyoun YOO, Daejeon (KR); Dae Young JANG, Daejeon (KR); Kyeongok KANG, Daejeon (KR)

(21) Appl. No.: 17/478,748

(22) Filed: Sep. 17, 2021

(30) Foreign Application Priority Data
Jan. 5, 2021 (KR) 10-2021-0000786

(51) Int. Cl. H04S 7/00

(52) U.S. Cl. CPC H04S 7/307; H04S 7/303

(57) ABSTRACT

A method of applying a Doppler effect to an object audio signal and a rendering apparatus performing the method are disclosed. The method includes determining a relative velocity between an audio object and an observer based on a velocity and a direction of the audio object and a position of the observer, determining whether to apply the Doppler effect based on the relative velocity, applying the Doppler effect based on the relative velocity to the object audio signal in response to a determination to apply the Doppler effect, and rendering an object audio signal to which the Doppler effect is applied.

### CROSS-REFERENCE TO RELATED APPLICATION

This application claims the benefit of Korean Patent Application No. 10-2021-0000786 filed on Jan. 5, 2021, in the Korean Intellectual Property Office, the entire disclosure of which is incorporated herein by reference for all purposes.

### BACKGROUND

### 1. Field of the Invention

One or more example embodiments relate to a method and apparatus for processing a Doppler effect in an audio signal, and more particularly, to a technology for applying a Doppler effect to an audio signal using a less calculation amount by calculating a relative velocity based on positions of an audio object and an observer and determining whether to apply the Doppler effect.

### 2. Description of Related Art

Recently, there is active research on an object audio signal to generate a more vivid or lively audio signal in an environment where a relationship between a sound source and an observer continuously changes, such as, for example, virtual reality (VR) or a game.

An audio signal may refer to an audio signal of which a sound source is considered an audio object and be rendered along with included information of the audio object including a position, size, and the like of the audio object.

MPEG-H 3D Audio, an audio coding standard developed by the Moving Picture Experts Group (MPEG)-H, includes an object audio and a scene audio in the standard along with a channel audio, and includes an object audio rendering method in the standard. In addition, standardization of metadata and a rendering technology for effectively rendering an audio signal in a six degrees of freedom (6DOF) VR environment will also be performed.

A Doppler effect may need to be applied to generate a vivid and realistic object audio signal when the positions of an audio object and an observer change with respect to each other. Here, the Doppler effect may refer to a phenomenon in which the observer observes a frequency different from a frequency of a wave source due to relative motions of the wave source and the observer.

When a sound source approaches an observer or listener, the observer or listener may hear a sound of a higher frequency than an original sound. When the sound source recedes from the observer or listener, the observer or listener may hear a sound of a lower frequency than the original sound.

In such a case, even though an absolute velocity of the sound source is constant, a moving direction of the sound source and a position of a user (or the observer) may affect a relative velocity. Thus, to apply the Doppler effect, the relative velocity may need to be determined. However, when the observer is not present in the moving direction of the sound source, a relative velocity between the sound source and the observer may change with time even though the absolute velocity of the sound source is constant. Thus, calculating an accurate relative velocity for applying the Doppler effect may not be easy.

In a case in which a position of a user is varying without being fixed, such as, for example, VR or a game, a relative velocity for applying the Doppler effect may not be readily calculated in advance, and thus accurately applying the Doppler effect to an object audio signal may not be easy. In addition, determining a relative velocity at each time for each frequency may increase greatly a calculation amount.

Thus, there is a desire for a technology for effectively processing a Doppler effect to render an object audio signal.

### SUMMARY

Example embodiments provide a method and apparatus for applying a Doppler effect with a low calculation amount when rendering an object audio signal. Example embodiments also provide a method and apparatus for calculating a relative velocity based on a distance between an audio object and an observer.

According to an aspect, there is provided a method of applying a Doppler effect to an object audio signal, the method including determining a relative velocity between an audio object and an observer based on a velocity and a direction of the audio object and a position of the observer, determining whether to apply the Doppler effect based on the relative velocity, applying the Doppler effect based on the relative velocity to the object audio signal in response to a determination to apply the Doppler effect, and rendering an object audio signal to which the Doppler effect is applied.

The determining of the relative velocity may include determining the relative velocity from the velocity of the audio object based on an angle formed among the direction of the audio object, the audio object, and the observer.

The determining whether to apply the Doppler effect may include comparing the relative velocity and a reference velocity, and determining to apply the Doppler effect when the relative velocity is greater than or equal to the reference velocity.

According to another aspect, there is provided a method of applying a Doppler effect to an object audio signal, the method including identifying information associated with a position of an audio object and a position of an observer based on a time interval, determining a relative velocity based on a distance between the audio object and the observer at a first time point and a distance between the audio object and the observer at a second time point adjacent to the first time point, applying the Doppler effect to the object audio signal based on the determined relative velocity, and rendering an object audio signal to which the Doppler effect is applied.

The method may further include determining whether to apply the Doppler effect based on the relative velocity. In response to a determination to apply the Doppler effect, the applying of the Doppler effect may include applying the Doppler effect based on the relative velocity to the object audio signal.

The determining whether to apply the Doppler effect may include comparing the relative velocity and a reference velocity, and determining to apply the Doppler effect when the relative velocity is greater than or equal to the reference velocity.

The determining of the relative velocity may include determining the relative velocity based on a difference between the distance between the audio object and the observer at the first time point and the distance between the audio object and the observer at the second time point, and on a difference between the first time point and the second time point.

According to still another aspect, there is provided a rendering apparatus performing a method of applying a Doppler effect to an object audio signal, the rendering apparatus including a processor. The processor may determine a relative velocity between an audio object and an observer based on a velocity and a direction of the audio object and a position of the observer, determine whether to apply the Doppler effect based on the relative velocity, apply the Doppler effect based on the relative velocity to the object audio signal in response to a determination to apply the Doppler effect, and render an object audio signal to which the Doppler effect is applied.

The processor may determine the relative velocity from the velocity of the audio object based on an angle formed among the direction of the audio object, the audio object, and the observer.

The processor may compare the relative velocity and a reference velocity, and determine to apply the Doppler effect when the relative velocity is greater than or equal to the reference velocity.

According to yet another aspect, there is provided a rendering apparatus performing a method of applying a Doppler effect to an object audio signal, the rendering apparatus including a processor. The processor may identify information associated with a position of an audio object and a position of an observer based on a time interval, determine a relative velocity based on a distance between the audio object and the observer at a first time point and a distance between the audio object and the observer at a second time point adjacent to the first time point, apply the Doppler effect to the object audio signal based on the determined relative velocity, and render an object audio signal to which the Doppler effect is applied.

The processor may determine whether to apply the Doppler effect based on the relative velocity, and apply the Doppler effect based on the relative velocity to the object audio signal in response to a determination to apply the Doppler effect.

The processor may compare the relative velocity and a reference velocity, and determine to apply the Doppler effect when the relative velocity is greater than or equal to the reference velocity.

The processor may determine the relative velocity based on a difference between the distance between the audio object and the observer at the first time point and the distance between the audio object and the observer at the second time point and on a difference between the first time point and the second time point.

Additional aspects of example embodiments will be set forth in part in the description which follows and, in part, will be apparent from the description, or may be learned by practice of the disclosure.

According to example embodiments described herein, it is possible to apply a Doppler effect with a less calculation amount to render an object audio signal. According to example embodiments described herein, it is also possible to calculate a relative velocity based on a distance between an audio object and an observer.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an example of a rendering apparatus according to an example embodiment;

FIG. 2 is a diagram illustrating an example of an operation of applying a Doppler effect to an object audio signal by a rendering apparatus according to an example embodiment;

FIGS. 3A and 3B are diagrams illustrating examples of positions of an audio object and an observer for calculating a relative velocity according to an example embodiment; and

FIGS. 4A through 4E are graphs illustrating examples of an angle-based relative velocity and a distance-based relative velocity according to an example embodiment.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The terminology used herein is for the purpose of describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof. In addition, terms such as first, second, A, B, (a), (b), and the like may be used herein to describe components. Each of these terminologies is not used to define an essence, order, or sequence of a corresponding component but used merely to distinguish the corresponding component from other component(s).

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein.

Also, in the description of example embodiments, detailed description of structures or functions that are thereby known after an understanding of the disclosure of the present application will be omitted when it is deemed that such description will cause ambiguous interpretation of the example embodiments. Hereinafter, examples will be described in detail with reference to the accompanying drawings, and like reference numerals in the drawings refer to like elements throughout.

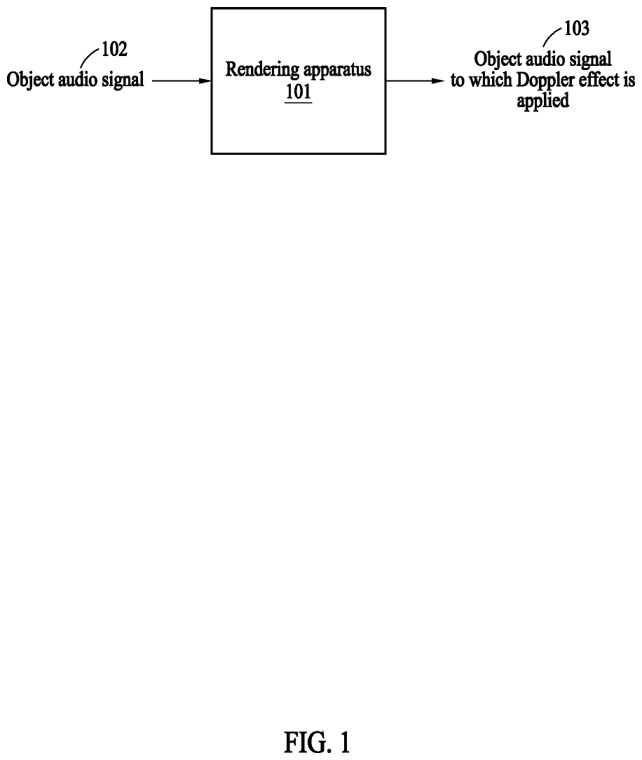

FIG. 1 is a diagram illustrating an example of a rendering apparatus according to an example embodiment.

The present disclosure relates to a technology for applying a Doppler effect when rendering an object audio signal. Referring to FIG. 1, a method of applying a Doppler effect to an object audio signal 102 may be performed by a rendering apparatus 101. The rendering apparatus 101 may correspond to a processor of an electronic device, such as, for example, a smartphone, a tablet computer, and a desktop.

Referring to FIG. 1, the rendering apparatus 101 may generate an object audio signal 103 to which the Doppler effect is applied by applying the Doppler effect to the object audio signal 102, and render the object audio signal 103 to which the Doppler effect is applied.

The rendering apparatus 101 may determine a relative velocity between an audio object and an observer to apply the Doppler effect to the object audio signal 102. The rendering apparatus 101 may determine whether to apply the Doppler effect by comparing the determined relative velocity and a reference velocity to increase the efficiency of calculation or computation.

The rendering apparatus 101 may effectively obtain the relative velocity between the audio object and the observer using a distance between the audio object and the observer in a previous frame, a distance between the audio object and the observer in a current frame, and a time difference between the previous frame and the current frame.

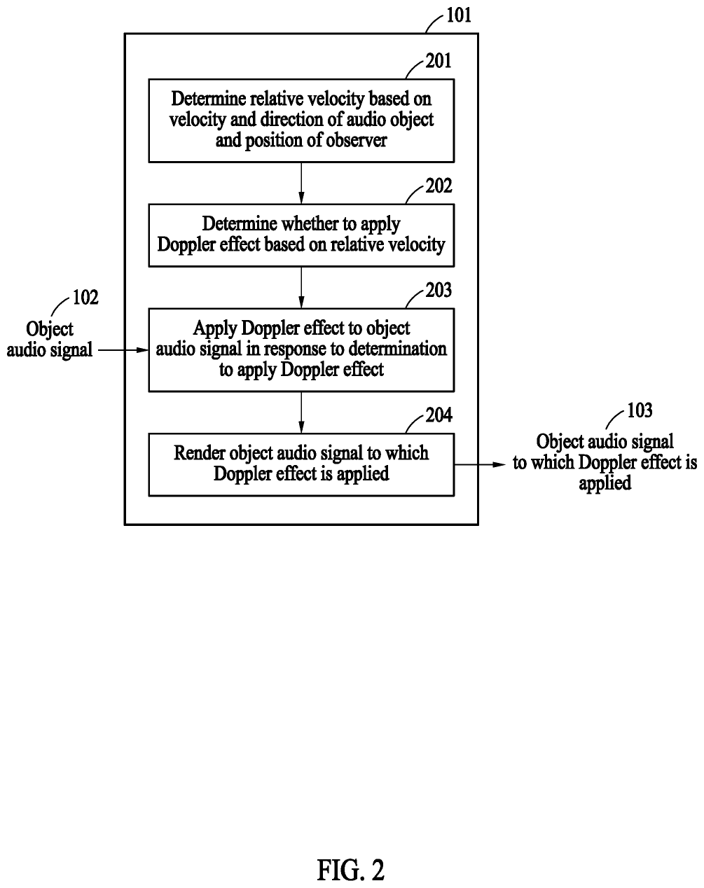

FIG. 2 is a diagram illustrating an example of an operation of applying a Doppler effect to an object audio signal by a rendering apparatus according to an example embodiment.

Referring to FIG. 2, in operation 201, the rendering apparatus 101 may determine a relative velocity between an audio object and an observer based on a velocity and a direction of the audio object and a position of the observer. According to an example embodiment, the rendering apparatus 101 may determine the relative velocity from the velocity of the audio object based on an angle formed by the direction of the audio object, the audio object, and the observer.

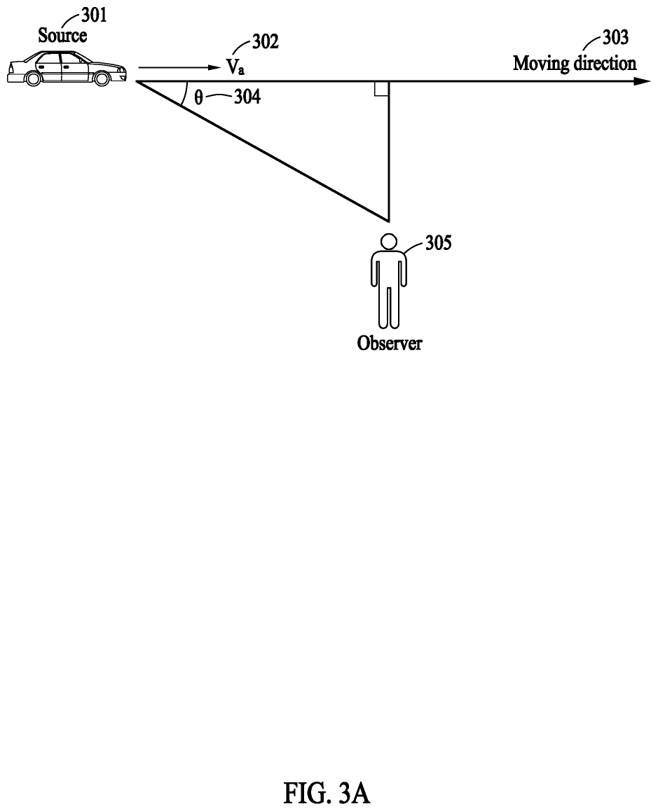

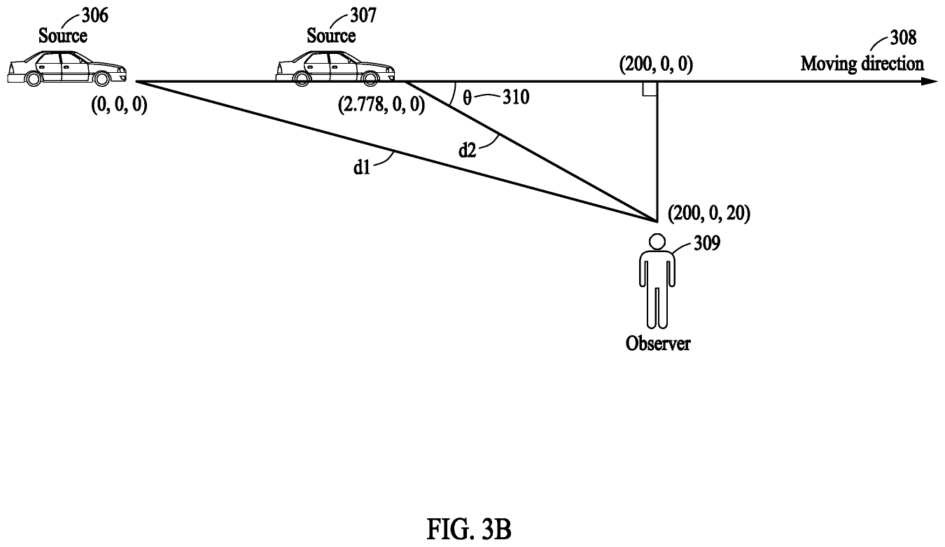

According to another example embodiment, the rendering apparatus 101 may determine the relative velocity between the audio object and the observer based on information associated with a position of the audio object and a position of the observer based on a time. A detailed method of determining a relative velocity to apply a Doppler effect will be described hereinafter with reference to FIGS. 3A and 3B.

In operation 202, the rendering apparatus 101 may determine whether to apply the Doppler effect based on the relative velocity. For example, the rendering apparatus 101 may compare the relative velocity and a reference velocity, and determine to apply the Doppler effect when the relative velocity is greater than or equal to the reference velocity.

In operation 203, when it is determined to apply the Doppler effect, the rendering apparatus 101 may apply the Doppler effect to an object audio signal 102 based on the determined relative velocity. In operation 204, the rendering apparatus 101 may render an object audio signal 103 to which the Doppler effect is applied.

The rendering apparatus 101 may identify information associated with a position of the audio object and a position of the observer based on a time interval. The rendering apparatus 101 may determine the relative velocity based on a distance between the audio object and the observer at a first time point and a distance between the audio object and the observer at a second time point adjacent to the first time point.

For example, the rendering apparatus 101 may determine the relative velocity based on a difference between the distance between the audio object and the observer at the first time point and the distance between the audio object and the observer at the second time point, and on a difference between the first time point and the second time point.

The rendering apparatus 101 may apply the Doppler effect to the object audio signal 102 based on the determined relative velocity. According to an example embodiment, the rendering apparatus 101 may determine whether to apply a Doppler effect based on a relative velocity. When it is determined to apply the Doppler effect, the rendering apparatus 101 may apply the Doppler effect to an object audio signal, for example, the object audio signal 102, based on the determined relative velocity.

The rendering apparatus 101 may then render an object audio signal 103 to which the Doppler effect is applied.

FIG. 3A is a diagram illustrating a position of an audio signal and a position of an observer used to calculate a relative velocity according to an example embodiment.

Referring to FIG. 3A, when there is an audio object 301 that moves consistently at a velocity of vₐ 302 in one direction, for example, a moving direction 303, and an angle θ 304 is formed by the moving direction 303 of the audio object 301, a position of the audio object 301, and a position of an observer 305, a relative velocity vᵣ between the audio object 301 and the observer 305 may be calculated as represented by Equation 1 below.

vᵣ=vₐ×cos(θ) [Equation 1]

In the case of a virtual reality (VR) content with six degrees of freedom (6DOF) of a movement of the observer 305, information associated with the velocity of the audio object 301 may be mostly uncertain, and information associated with the position of the audio object 301 and information associated with the position of the observer 305 may be determined at regular time intervals.

According to an example embodiment, when the information associated with the position of the audio object 301 and the position of the observer 305 is given each time interval, the velocity of the audio object 301 may be determined as represented by Equation 2 below using information associated with positions of the audio object 301 at two adjacent time points t₁ and t₂. For example, t₂ may be greater than t₁.

$${v}_{a} = ( - 1 ) \times \frac{( p 2 - p 1 )}{( t 2 - t 1 )} \qquad [ Equation 2 ]$$

In Equation 2, vₐ (e.g., 302) denotes a velocity in a moving direction (e.g., 303) of an object (e.g., 301). p₁ denotes a position of the object at a time point t₁, and p₂ denotes a position of the object at a time point t₂. A vector of the moving direction 303 of the audio object 301 may be determined as represented by Equation 3 below.

d=(xₜ₂−xₜ₁,yₜ₂−yₜ₁,zₜ₂−zₜ₁) [Equation 3]

In Equation 3, xₜ₁, yₜ₁, and zₜ₁ denote an x-axis coordinate, a y-axis coordinate, and a z-axis coordinate, respectively, corresponding to a position of the audio object 301 at the time point t₁ in spatial coordinates including an x axis, a y axis, and a z axis. xₜ₂, yₜ₂, and zₜ₂ denote an x-axis coordinate, a y-axis coordinate, and a z-axis coordinate, respectively, corresponding to a position of the audio object 301 at the time point t₂ in the spatial coordinates.

In addition, the angle θ 304 between the audio object 301 and the observer 305 may be determined by an angle between a vector d of the moving direction 303 of the audio object 301 and a vector that passes a position of the observer 305 and a position of the audio object 301. The angle θ 304 between the audio object 301 and the observer 305 may be determined based on an angle formed by a direction of the audio object 301, the audio object 301, and the observer 305.

For example, the angle θ 304 between the position of the audio object 301 and the observer 305 may be determined as represented by Equation 4.

θ=∠{(xₜ₂−xₜ₁,yₜ₂−yₜ₁,zₜ₂−zₜ₁),(x′ₜ₂−xₜ₂,y′ₜ₂−yₜ₂,z′ₜ₂−zₜ₂)} [Equation 4]

In Equation 4, x′ₜ₂, y′ₜ₂, and z′ₜ₂ denote an x-axis coordinate, a y-axis coordinate, and a z-axis coordinate, respectively, corresponding to a position of the observer 305 at the time point t₂. Thus, even though a velocity of the audio object 301 is uncertain, a relative velocity may be determined. However, when the position of the observer 305 changes with time, determining such a relative velocity may increase excessively an amount of calculation or computation.

According to an example embodiment, when information associated with positions of the audio object 301 and the observer 305 is identified at regular time intervals, a rendering apparatus may determine a relative velocity using information associated with a distance between the audio object 301 and the observer 305 at two time intervals.

For example, the rendering apparatus may determine an approximate value of a relative velocity determined by Equation 1, using Equation 5 below with a less calculation amount.

$${v}_{r}^{′} = ( - 1 ) \times \frac{( d 2 - d 1 )}{( t 2 - t 1 )} \qquad [ Equation 5 ]$$

In Equation 5, vᵣ′ denotes a relative velocity between the audio object 301 and the observer 305. t₂ denotes a current time point, and t₁ denotes a previous time point. d₂ denotes a distance between the audio object 301 and the observer 305 at the current time point t₂, and d₁ denotes a distance between the audio object 301 and the observer 305 at the previous time point t₁.

A distance between the audio object 301 and the observer 305 may be continuously calculated in a process of rendering an object audio signal. Thus, by determining a relative velocity using Equation 5 above, it is possible to calculate the relative velocity with less calculation amount, compared to using Equation 1, even though a position of the observer 305 changes with time.

Hereinafter, approximation of a relative velocity of Equation 1 will be described as one of the methods of calculating a relative velocity by comparing a result of calculating a relative velocity using Equation 1 and a result of calculating a relative velocity using Equation 5.

FIG. 3B is a diagram illustrating positions 306 and 307 of an audio object and a position (200, 0, 20) of an observer 309, at a first time point and a second time point.

For example, the second time point may be a time point subsequent to the first time point, and elapsed by 0.1 seconds from the first time point. FIG. 3B illustrates an example where an audio object is traveling 200 meters (m) in a moving direction 308 at a velocity of 100 kilometers per hour (km/h) and the observer 309 is at the position (200, 0, 20) which is 20 meters (m) away from the moving direction 308 in a vertical direction. In this example, an angle θ 310 between a position of the audio object and the observer 309 may be approximately 5.711 degrees)(°.

In the example of FIG. 3B, a relative velocity calculated using Equation 1 may be 27.636 meters per second (m/sec), and a relative velocity calculated using Equation 5 may be 27.6380 m/sec. A difference between the relative velocities calculated by Equations 1 and 5, respectively, may be less than 1/1000 of a relative velocity.

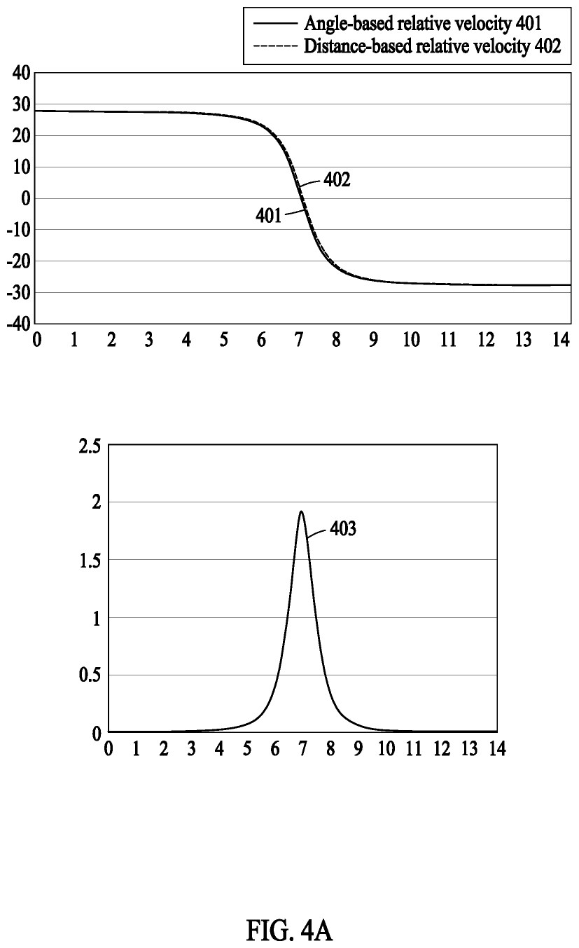

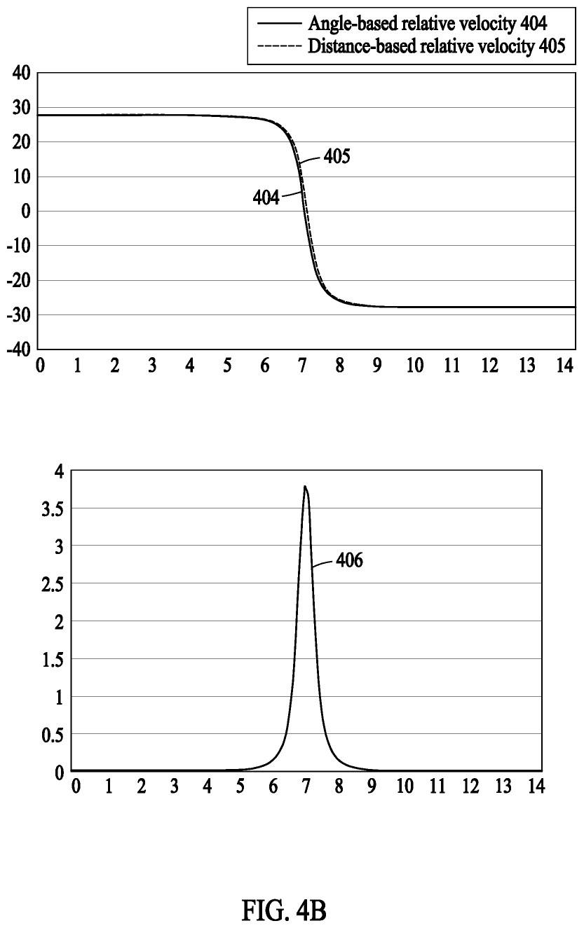

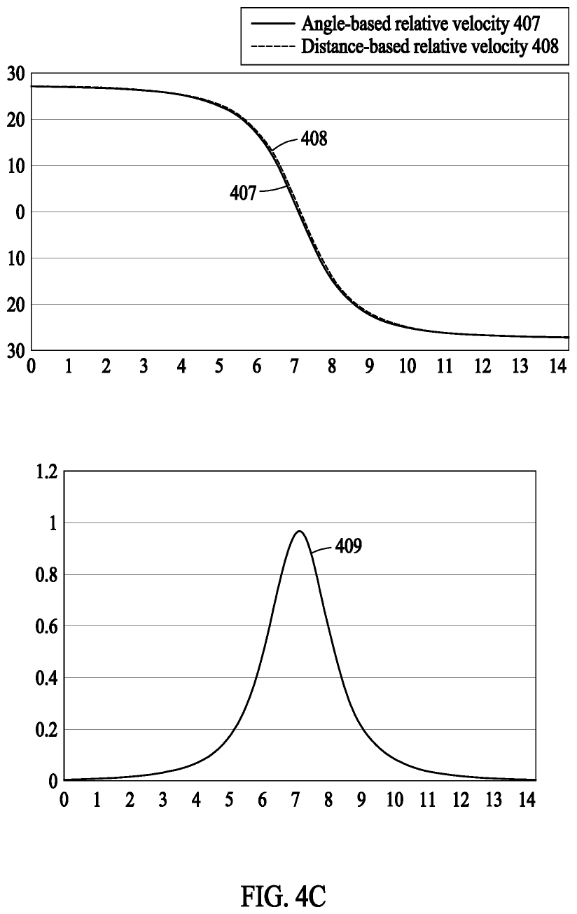

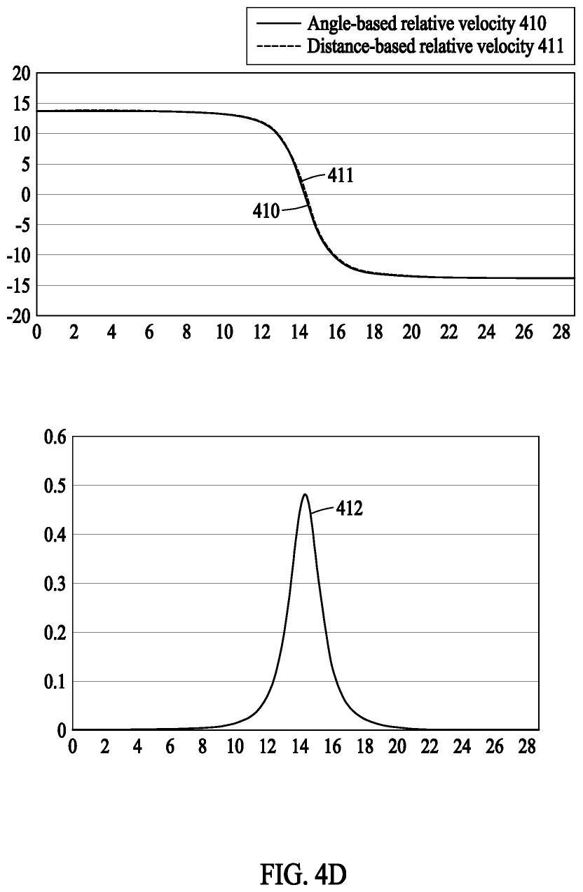

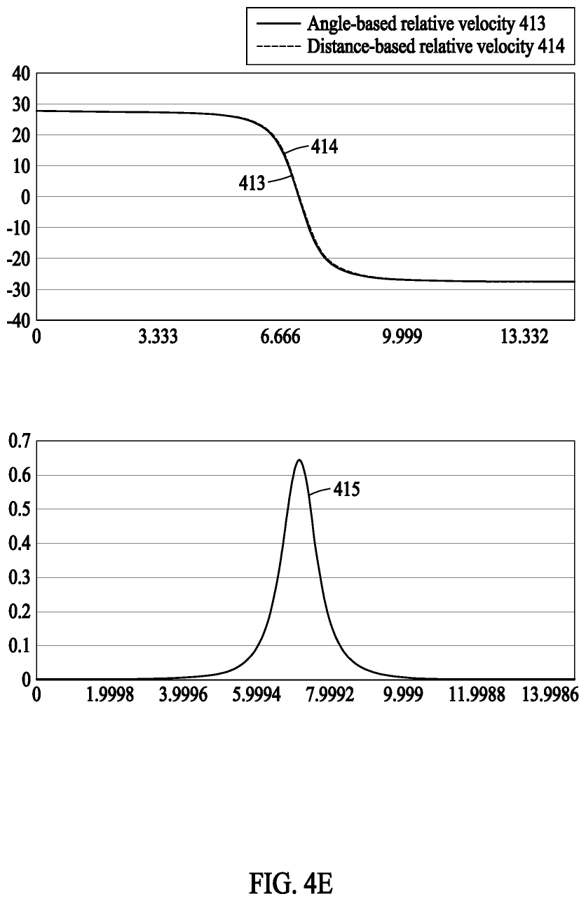

FIGS. 4A through 4E are graphs illustrating examples of an angle-based relative velocity and examples of a distance-based relative velocity according to an example embodiment.

An angle-based relative velocity may correspond to a relative velocity calculated using Equation 1 and a distance-based relative velocity may correspond to a relative velocity calculated using Equation 5.

An upper portion of FIG. 4A illustrates a graph of an angle-based relative velocity 401 and a distance-based relative velocity 402 calculated every 0.1 seconds as described above with reference to FIG. 3B. In this graph, a horizontal axis indicates time (second) and a vertical axis indicates velocity (m/s).

A lower portion of FIG. 4A illustrates a graph of a difference 403 between the angle-based relative velocity 401 and the distance-based relative velocity 402 illustrated in the upper portion of FIG. 4A. In this graph, a horizontal axis indicates time (second) and a vertical axis indicates an absolute value of the difference 403 between the angle-based relative velocity 401 and the distance-based relative velocity 402.

Referring to the upper portion and the lower portion of FIG. 4A, the difference 403 between the angle-based relative velocity 401 and the distance-based relative velocity 402 may be great in an interval from 5 seconds to 9 seconds in which a magnitude of the angle-based relative velocity 401 changes drastically. In addition, the difference 403 between the angle-based relative velocity 401 and the distance-based relative velocity 402 may not be great in an interval from 0 to 5 seconds and an interval from 9 to 14 seconds.

A change in magnitude of the angle-based relative velocity 401 may be determined based on positions of an audio object and an observer, a velocity of the audio object in a moving direction, or a time interval in which the positions of the audio object and the observer are measured.

An upper portion of FIG. 4B illustrates a graph of an angle-based relative velocity 404 and a distance-based relative velocity 405 when a position of an observer is closer to an audio object compared to the case described above with reference to FIG. 3B.

A lower portion of FIG. 4B illustrates a graph of a difference 406 between the angle-based relative velocity 404 and the distance-based relative velocity 405 when the position of the observer is closer to the audio object compared to the case described above with reference to FIG. 3B.

For example, FIG. 4A is a graph of a relative velocity calculated when the position of the observer is (200, 0, 20), whereas FIG. 4B is a graph of a relative velocity calculated when the position of the observer is (200, 0, 10) under the same condition.

Referring to FIG. 4B, a magnitude of the angle-based relative velocity 404 changes more greatly than the case described above with reference to FIG. 4A, and thus the difference 406 between the angle-based relative velocity 404 and the distance-based relative velocity 405 may be greater than the difference 403 described above with reference to FIG. 4A.

An upper portion of FIG. 4C illustrates a graph of an angle-based relative velocity 407 and a distance-based relative velocity 408 when a position of an observer is farther from an audio object compared to the case described above with reference to FIG. 3B.

A lower portion of FIG. 4C illustrates a graph of a difference 409 between the angle-based relative velocity 407 and the distance-based relative velocity 408 when the position of the observer is farther from the audio object compared to the case described above with reference to FIG. 3B.

For example, FIG. 4A is a graph of a relative velocity calculated when the position of the observer is (200, 0, 20), whereas FIG. 4C is a graph of a relative velocity calculated when the position of the observer is (200, 0, 40) under the same condition.

Referring to FIG. 4C, a magnitude of the angle-based relative velocity 407 changes less than the case described above with reference to FIG. 4A, and thus the difference 409 between the angle-based relative velocity 407 and the distance-based relative velocity 408 may be less than the difference 403 described above with reference to FIG. 4A.

An upper portion of FIG. 4D illustrates a graph of an angle-based relative velocity 410 and a distance-based relative velocity 411 when a velocity of an audio object decreases compared to the case described above with reference to FIG. 3B.

A lower portion of FIG. 4D illustrates a graph of a difference 412 between the angle-based relative velocity 410 and the distance-based relative velocity 411 when the velocity of the audio object decreases compared to the case described above with reference to FIG. 3B.

For example, FIG. 4A is a graph of a relative velocity calculated when the velocity of the audio object is 100 km/h, whereas FIG. 4D is a graph of a relative velocity calculated when the velocity of the audio object is 50 km/h under the same condition.

Referring to FIG. 4D, as a time used to pass the same interval increases by a factor of 2 times, a magnitude of the angle-based relative velocity 410 may change more gradually than the case described above with reference to FIG. 4A, and thus the difference 412 between the angle-based relative velocity 410 and the distance-based relative velocity 411 may be less than the difference 403 described above with reference to FIG. 4A.

An upper portion of FIG. 4E illustrates a graph of an angle-based relative velocity 413 and a distance-based relative velocity 414 when a time interval in which positions of an audio object and an observer are measured is shorter compared to the case described above with reference to FIG. 3B.

A lower portion of FIG. 4E illustrates a graph of a difference 415 between the angle-based relative velocity 413 and the distance-based relative velocity 414 when the time interval in which the positions of the audio object and the observer are measured is shorter compared to the case described above with reference to FIG. 3B.

For example, FIG. 4A is a graph of a relative velocity calculated when the time interval in which the positions of the audio object and the observer are measured is 0.1 seconds, whereas FIG. 4E is a graph of a relative velocity calculated when the time interval in which the positions of the audio object and the observer are measured is 1/30 seconds under the same condition.

Referring to FIG. 4E, a magnitude of the angle-based relative velocity 413 changes more gradually than the case described above with reference to FIG. 4A, and thus the difference 415 between the angle-based relative velocity 413 and the distance-based relative velocity 414 may be less than the difference 403 described above with reference to FIG. 4A.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The apparatus and method described herein according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include all computer storage media.

In addition, non-transitory computer-readable media may be any available media that may be accessed by a computer and may include both computer storage media and transmission media.

Although the present disclosure includes details of a plurality of specific example embodiments, the details should not be construed as limiting any invention or a scope that can be claimed, but rather should be construed as being descriptions of features that may be peculiar to specific example embodiments of specific inventions. Specific features described in the present disclosure in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In a specific case, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present disclosure and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. A method of applying a Doppler effect to an object audio signal, the method comprising:
determining a relative velocity between an audio object and an observer based on a velocity and a direction of the audio object and a position of the observer;
determining whether to apply the Doppler effect based on the relative velocity;
in response to a determination to apply the Doppler effect, applying the Doppler effect based on the relative velocity to the object audio signal; and
rendering an object audio signal to which the Doppler effect is applied.

2. The method of claim 1, wherein the determining of the relative velocity comprises:
determining the relative velocity from the velocity of the audio object based on an angle formed among the direction of the audio object, the audio object, and the observer.

3. The method of claim 1, wherein the determining whether to apply the Doppler effect comprises:
comparing the relative velocity and a reference velocity, and determining to apply the Doppler effect when the relative velocity is greater than or equal to the reference velocity.

4. A method of applying a Doppler effect to an object audio signal, the method comprising:
identifying information associated with a position of an audio object and a position of an observer based on a time interval;
determining a relative velocity based on a distance between the audio object and the observer at a first time point and a distance between the audio object and the observer at a second time point adjacent to the first time point;
applying the Doppler effect to the object audio signal based on the determined relative velocity; and
rendering an object audio signal to which the Doppler effect is applied.

5. The method of claim 4, further comprising: determining whether to apply the Doppler effect based on the relative velocity,
wherein the applying of the Doppler effect comprises:
in response to a determination to apply the Doppler effect, applying the Doppler effect based on the relative velocity to the object audio signal.

6. The method of claim 4, wherein the determining whether to apply the Doppler effect comprises:
comparing the relative velocity and a reference velocity, and determining to apply the Doppler effect when the relative velocity is greater than or equal to the reference velocity.

7. The method of claim 4, wherein the determining of the relative velocity comprises:
determining the relative velocity based on a difference between the distance between the audio object and the observer at the first time point and the distance between the audio object and the observer at the second time point, and on a difference between the first time point and the second time point.

8. A rendering apparatus performing a method of applying a Doppler effect to an object audio signal, the rendering apparatus comprising:
a processor,
wherein the processor is configured to:
determine a relative velocity between an audio object and an observer based on a velocity and a direction of the audio object and a position of the observer, determine whether to apply the Doppler effect based on the relative velocity, apply the Doppler effect based on the relative velocity to the object audio signal in response to a determination to apply the Doppler effect, and render an object audio signal to which the Doppler effect is applied.

9. The rendering apparatus of claim 8, wherein the processor is configured to:
determine the relative velocity from the velocity of the audio object based on an angle formed among the direction of the audio object, the audio object, and the observer.

10. The rendering apparatus of claim 8, wherein the processor is configured to:
compare the relative velocity and a reference velocity, and determine to apply the Doppler effect when the relative velocity is greater than or equal to the reference velocity.
